(19) United States
(12) Patent Application Publication
(10) Pub. No.: US 2007/0073694 A1
(43) Pub. Date: Mar. 29, 2007

(54) Method and apparatus of determining access rights to content items

(76) Inventors: Jerome Picault, Paris (FR); Frank R. Bentley, Palatine, IL (US); David R. Bourne, Newbury (GB); Nicolas Lhuillier, Versailles (FR); Crysta J. Metcalf, Cary, IL (US); Joseph F. Wodka, Hoffman Estates, IL (US)

Correspondence Address: MOTOROLA, INC., 1303 EAST ALGONQUIN ROAD, IL01/3RD, SCHAUMBURG, IL, 60196, US

(21) Appl. No.: 11/235,040

(22) Filed: Sep. 26, 2005

(51) Int. Cl. G06F 17/30

(52) U.S. Cl. 707/9

(57) ABSTRACT

Access rights to content items, such as personal photos etc, is determined in response to content metadata and requester metadata. A plurality of content items is stored in a content item store. An access right processor determines content metadata for the plurality of content items. When a request for a content item is determined, the access right processor determines requester metadata for the request. The requester metadata comprises data of a characteristic of a requester of the request. The access right processor then determines access rights in response to the content metadata and the requester metadata. If a positive access right is determined, the requested content item may be sent to the requester. The access right may further be determined in response to past usage data or context data for the content items. The invention may allow an improved and automated access right management.

### FIELD OF THE INVENTION

The invention relates to an apparatus and method of determining access rights to content items such as personal content data items.

### BACKGROUND OF THE INVENTION

In recent years the generation, provision and use of digital information has increased dramatically and it is becoming commonplace for people to create personal digital information which is stored electronically. For example, address books, digital photos, video, music and many other types of content items are increasingly being generated and stored electronically by average consumers. Furthermore, the access to, distribution and sharing of digital content items is becoming increasingly popular and people today have access to increasing amounts of digital data, which they like to or need to share with others. As a consequence, the control of access to content items is becoming increasingly important to protect the user's privacy, to manage the rights of distribution and to restrict the use of the content.

Digital Rights Management (DRM) technologies have been (and are being) developed to protect usage and distribution of commercial multimedia content. Such DRM technologies tend to focus on copy protection and distribution control.

However, very few rights management technologies currently exist which are suitable for protecting personal data and individual users content item rights. For example, unlike commercial content, personal content does not include a license that explicitly defines access and usage rules for the content item. For example, a digital photograph taken by a user and stored on the user's mobile telephone is typically stored as a simple image file without any associated rights information. However as usage and sharing are increasing, there is an increasing need to properly manage access rights for such content. For example, for user privacy and personal security reasons, data stored on user devices should preferably be provided with access control protection ensuring a controlled distribution and usage of the content.

Such access control could be managed manually by the user explicitly granting or refusing access to individual content items when a request is received. However, such manual operation is cumbersome, complex and impractical in most applications. In order to overcome this problem, current technologies require that the content-owner for each piece of content a-priori defines all the potential users who is allowed access.

However, such an approach is disadvantageous for a number of reasons, including:
Manual access-control setting is a tedious mechanism, especially if the amount of data to process is substantial and increasing. Therefore, most users (even those who are aware of security threats) tend not to manage the access-rights optimally. For example, users tend to simply apply the same rules to all of their content. This results in a suboptimal rights management and typically results in users making either all content available to everyone or to make no content available.
Additionally, in a dynamic environment, the appropriate access rules tend to change dynamically and the application of static rules will not reflect these dynamic variations. For example, users may meet other users resulting in a desire to exchange content with other users who are not initially registered for accessing the content item. This currently requires an update of the access rights for all the pieces of content that the new users need access to.

Accordingly, the known access control techniques typically do not reflect the user's requirements and preferences. Rather, known access rights management algorithms tend to be inflexible and cumbersome to operate and are not optimal for protection of e.g. content items generated by end consumers.

Preferably, the access control mechanism should reduce the involvement of the content-owner and should automatically adapt to both new pieces of content and new users.

Hence, an improved system for content access management would be advantageous and in particular a system allowing flexibility, improved dynamic performance, reduced need for user interaction, improved performance and/or access right management which more closely reflects the user's preferences would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus comprising: memory for storing a plurality of content items; and a processor coupled to the memory and arranged to determine content metadata for the plurality of content items; receive a request for a first content item of the content items; determine requester metadata for the request, the requester metadata comprising data of a characteristic of a first requester of the request; and determine an access right for the first requester to the first content item in response to the content metadata and the requester metadata.

The invention may allow improved access management for content items. In particular, a given requester characteristic indicated by metadata may result in access to content items with suitable content item metadata. Thus, the combined evaluation of different types of metadata may be used to determine an access right.

An automatic determination of the access right may be achieved in response to characteristics of the requester and the content data. The use of metadata may allow a determination of access rights which does not require that the content items and/or requester are identified and assigned access rights before the request is made. The access right may be determined with no predefined access rights being in place for the specific requester or for the specific content item. A flexible and/or dynamically adaptable access right determination apparatus may be determined.

The apparatus may for example be a user device such as a mobile phone or personal computer.

According to an optional feature of the invention, the processor is further arranged to determine past usage data for the plurality of content items; and to further determine the access right in response to the usage data.

This may allow improved access rights performance. In particular, a more accurate determination of access rights reflecting the user's preferences may be achieved. Alternatively or additionally, the feature may allow an automatic adaptation to current conditions in a dynamic environment. In particular, a learning system may be implemented wherein access rights and rights-generating rules are automatically determined in response to previous access right determinations and existing rules. The usage data may relate to an access of content items by previous requests.

According to an optional feature of the invention, the processor is arranged to determine the access right as a positive access right if the first content item meets a similarity criterion with respect to another content item for which the past usage data indicates that a requester meeting a similarity criterion with respect to the first requester has obtained a positive access right.

This may allow improved access rights performance. In particular, a more accurate determination of access rights reflecting the user's preferences may be achieved. Alternatively or additionally, the feature may allow an automatic adaptation to current conditions in a dynamic environment.

For example, a positive access right may be determined for the request if a similar requester has previously been allowed access to a similar content item. Any suitable similarity criteria may be used.

A positive access right is indicative of the requester being allowed access to the first content item.

According to an optional feature of the invention, the processor is further arranged to determine contextual metadata for the plurality of content items; and to further determine the access right in response to the contextual metadata.

This may allow improved access rights performance. In particular, a more accurate determination of access rights reflecting the user's preferences may be achieved. Alternatively or additionally, the feature may allow an automatic adaptation to current conditions in a dynamic environment.

The contextual metadata may not relate directly to the contents of the content items but to a context associated with the individual content items such as a location or time when the content item was created.

According to an optional feature of the invention, the contextual metadata relates to a user context for a user associated with each of the plurality of content items. This may allow improved access right management. The user context may for example be a context of a user when the content item was created.

According to an optional feature of the invention, the processor is further arranged to determine a category of the first requester in response to the requester metadata; and to determine the access right as a positive access right in response to a determination that at least one other requester belonging to that category has positive access rights.

This may provide a practical and low complexity implementation and may provide efficient and accurate access rights management. The category may for example be determined in response to a similarity criterion or may for example be an explicit category indicated by the requester metadata.

According to an optional feature of the invention, the processor is arranged to determine the access rights of the at least one other requester in response to an access right determination for a previous request by the at least one other requester for the first content item.

This may provide a practical and low complexity implementation and may provide efficient and accurate access right management. The category may be determined in response to past usage data. The access rights of the at least one requester may in particular be a positive access right if the previous request resulted in a positive access right.

According to an optional feature of the invention, the processor is further arranged to determine a category of the first content item in response to the content metadata; and to determine the access right as a positive access right in response to a determination that the first requester has a positive access right to at least one other content item belonging to that category.

This may provide a practical and low complexity implementation and may provide efficient and accurate access rights management. The category may for example be determined in response to a similarity criterion or may for example be an explicit category indicated by the content metadata.

According to an optional feature of the invention, the processor is arranged to determine the access rights for the at least one other content item in response to an access right determination for a previous request by the first requester for the at least one other content item.

This may provide a practical and low complexity implementation and may provide efficient and accurate access rights management. A content item category may be determined in response to past usage data. The access rights of the at least one requester may in particular be a positive access right if the previous request resulted in a positive rights determination.

According to an optional feature of the invention, the processor comprises access right associations linking at least a first content item characteristic with a first requester characteristic; and the processor is arranged to determine a positive access right if a requester and a content item of a request by the requester are linked by an access rights association.

This may provide an accurate access right determination which may automatically and with low complexity determine if access should be allowed to the first content item. The first requester characteristic may for example be an identity of the requester.

According to an optional feature of the invention, the processor is further arranged determine a requester category of the first requester in response to the requester metadata; and to determine the access right in response to an access rights association for at least one other requester of the requester category.

This may provide a low complexity implementation with high performance access rights management. The access right determination may e.g. be a simple determination allowing access to the first content item if a given number(e.g. one) of requesters in the requester category is linked to the first content item by the an access right association.

According to an optional feature of the invention, the processor is further arranged determine a content category of the first content item in response to the content metadata; and to determine the access right in response to an access rights association for at least one content item of the content category.

This may provide a low complexity implementation with high performance access rights management. The access right determination may e.g. be a simple determination allowing access to the first content item if the requester is linked to a given number (e.g. one) of the content items in the content category.

According to an optional feature of the invention, the processor is arranged to generate access right associations in response to a determination of an access right for a requester for a content item.

This may allow efficient and low complexity implementation with high performance access right management.

The access right associations may be generated in response to user data. For example, if an access right determination results in a positive access right, the access right determination may alternatively or additionally be in response to other parameters, criteria or algorithms than the content metadata and the requester metadata. For example, an access right may be determined by a user manually allowing access and this may result in the generation of a new access right association which may subsequently be used to automatically determine access rights for other content items.

According to an optional feature of the invention, the processor is arranged to determine a positive access right if the content metadata for the first content item comprises an access right association to a characteristic of the first requester. The characteristic may specifically be an identity. This may allow efficient access rights determination and/or low complexity implementation.

According to an optional feature of the invention, the processor is arranged to determine the requester metadata in response to locally stored data for the first requester. This may allow efficient implementation and/or improved rights management. For example, the feature may reduce or obviate the requirement for external information to be provided or accessible. The requester metadata may for example be extracted from a local address book stored at the apparatus.

According to an optional feature of the invention, the processor is arranged to determine the access right in response to a user defined access right for at least one different content item. This may result in improved access rights management. For example, the user may define access right rules which may subsequently be used to automatically determine access rights.

According to an optional feature of the invention, the apparatus comprises a user interface for presenting the access rights to the user. This may provide improved control. For example, the processor may automatically determine an access right which is suggested to the user who may accept or reject the determination.

According to an optional feature of the invention, the apparatus comprises an interface for providing access for the first requester to the first content item only if a positive access right is determined. The access may for example be in the form of the apparatus sending the content item to the requester if the access right determination results in access being allowed.

According to a second aspect of the invention, there is provided a method of determining access rights to content items comprising: storing a plurality of content items; determining content metadata for the plurality of content items; receiving a request for a first content item of the content items; determining requester metadata for the request, the requester metadata comprising data of a characteristic of a first requester of the request; and determining an access right for the first requester to the first content item in response to the content metadata and the requester metadata.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example block diagram of an apparatus in accordance with some embodiments of the invention;

FIG. 2 illustrates a flow chart of a method of determining access rights to content items in accordance with some embodiments of the invention;

FIG. 3 illustrates a specific content item access example;

FIG. 4 illustrates another specific content item access example;

FIG. 5 illustrates another specific content item access example; and

FIG. 6 illustrates another specific content item access example.

### DETAILED DESCRIPTION OF EMBODIMENTS OF THE INVENTION

As more and more content is created and stored electronically, it is becoming an increasing problem to manage access rights to such content. Access rights are conventionally handled in the human domain by agreements, licenses etc. However, as this is impractical for e.g. personal content items which are frequently generated ad-hoc and in large numbers, it is increasingly desirable to provide technical means for allowing access rights to be at least partially managed in the technical domain rather than in the human domain. However, known systems for Digital Rights Management (DRM) still require that the rights are explicitly defined and are impractical to personal content items.

In the following, embodiments of the invention are described which provides an automated approach to determination of access rights for personal digital content stored on a user's device.

The description focuses on embodiments of the invention applicable to a mobile device (e.g. a mobile phone) storing personal content items such as pictures, address books, digitally encoded music files etc. However, it will be appreciated that the invention is not limited to this application but may be applied e.g. to many other devices and content item types.

In the described embodiments, access rights may specifically be inferred automatically taking into account the characteristics of the requested content, the social relationship that may exist between the requester and the owner as well as an access right preference of the owner. This approach is e.g. applicable to content that does not require a license to be accessed and which does not have any specifically defined DRM rules or rights. Such content includes (but is not limited to): personal pictures, contents of a phone-book, contents of Personal Information Management applications (agenda), location data (e.g. information provided by built-in GPS receiver) etc. Rather than relying on explicitly defined rights for each individual content item, the described embodiments allow access rights to be determined based on content metadata for the content item. Such content metadata may typically be generated automatically and for other purposes and the embodiments may thus allow rights management to be performed for ordinary content items which are created without any specific access rights consideration.

Metadata may be structured information that describes, explains, locates, or otherwise makes it easier to retrieve, use or manage an information resource.

The system may be used in addition to standard DRM techniques.

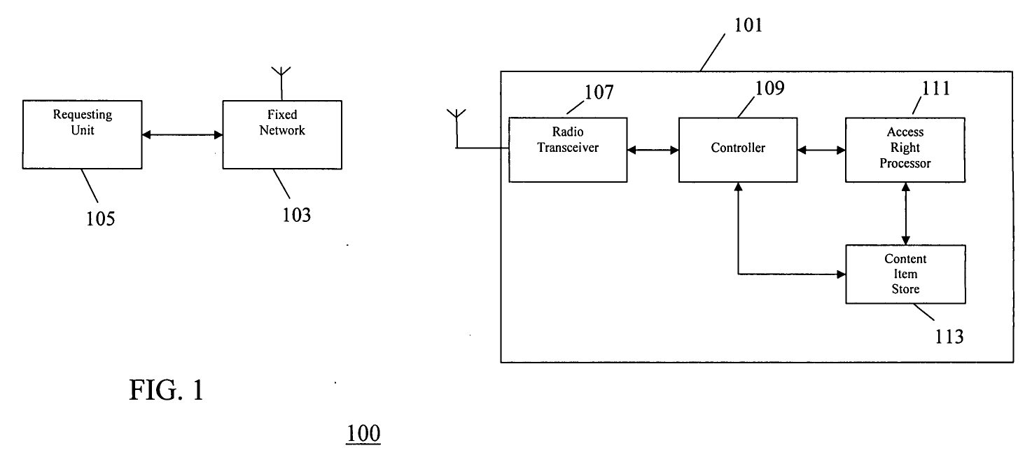

FIG. 1 illustrates an example block diagram of an apparatus 101 in accordance with the invention. In the specific example, the apparatus is a mobile phone 101 communicating with a fixed network 103 over an air interface of a cellular communication system.

In the example of FIG. 1, a requesting unit 105 is connected to the fixed network 103. The user of the requesting unit 105 may request access to some content stored on the mobile phone 101. The user of the requesting unit 105 may for example become aware of a content item stored at the mobile phone 101 by the user of the mobile phone 101 publishing this information on a bulletin board e.g. on the Internet. In the example, the mobile phone 101 comprises functionality for determining an access right for the request and in particular comprises functionality for allowing or refusing the requesting unit 105 access to the content item. If the access is determined as a positive access right, the mobile phone 101 furthermore comprises functionality for transmitting the content item to the requesting unit 105.

The mobile phone 101 comprises a radio transceiver 107 which is responsible for communicating with a base station of the fixed network 103 over the air interface in accordance with the Technical Specifications of the cellular communication system as will be well known to the person skilled in the art.

The radio transceiver 107 is coupled to a controller 109 which controls the operation of the mobile phone 101. The controller 109 is coupled to an access right processor 111 which is further coupled to a content item store 113. The content item store comprises a plurality of content items such as for example digital photos taken by a camera built into the phone.

When the controller 109 receives the request from the requesting unit 105, it forwards this to the access right processor 111. In response, the access right processor 111 proceeds to determine an access right for the request.

In particular, the access right processor 111 determines content metadata for the plurality of content items stored in the content item store 113. In addition, the application processor 101 determines requester metadata for the received request. The requester metadata comprises data related to at least one characteristic of the requester of the request. The requester may for example be the user of the requesting unit 105 or may be the requesting unit 105 itself. Thus, the characteristics of the requester metadata may for example relate to a person using the requesting unit 105 or may alternatively or additionally relate to the requesting unit 105. The application processor 101 then proceeds to determine the access right in response to the content metadata for the requested content item and the requester metadata. If a suitable match is found, the application processor 101 proceeds to determine a positive access right allowing access and otherwise a negative access right is determined refusing access to the content item.

The application processor 101 then feeds the determined access right back to the controller 109 and if a positive access right is determined, the controller 109 proceeds to retrieve the requested content item from the content item store 113 and to transmit it to the requesting unit 105. If a negative access right is determined, the controller 109 transmits a refusal message to the requesting unit 105.

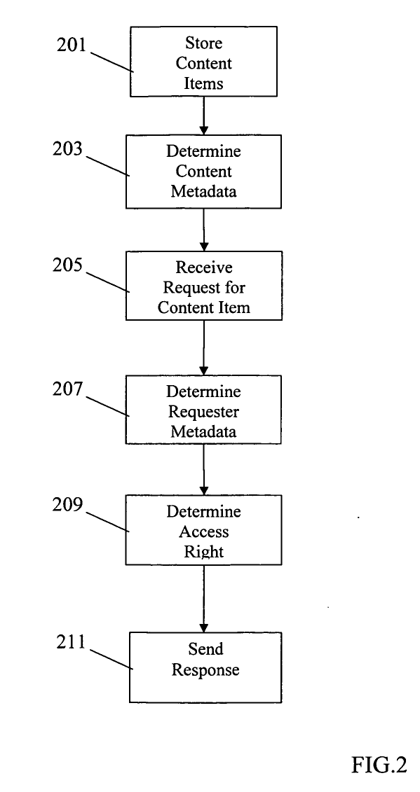

FIG. 2 illustrates a flow chart of a method of determining access rights to content items in accordance with some embodiments of the invention. The method is applicable to the mobile phone 101 of FIG. 1 and will be described with reference to this.

The method initiates in step 201 wherein content items are generated and stored in the content item store 113.

Step 201 is followed by step 203 wherein content metadata is determined for the content items. It will be appreciated that in some embodiments, content metadata may be created when the content items are stored and the content metadata may be stored with the content items. In such, embodiments, step 203 may simply comprise retrieving the stored content metadata from the content item store 113.

This content metadata consists of information about the content itself such as e.g. date, type, format, genre, artist, objects in content etc.

The content metadata may for example be compliant with existing standards, such as MPEG-7 which is formally named “Multimedia Content Description Interface”, (ISO MPEG-7, Part 5—Multimedia Description Schemes, ISO/IEC JTC1/SC29/WG11/N4242, (October 2001)). MPEG-7 is an extensive and extendible metadata standard that provides a rich set of tools to describe the structure and semantics of multimedia content. An MPEG-7 Descriptor can describe both low-level features such as colour or texture characteristics, and high-level features that carry semantic meaning such as location and person names. An organised collection of Descriptors defines a Description Scheme, which enables the description of complex objects, such as persons or events, associated with the multimedia content. The overall syntax of MPEG-7 descriptors is defined by the Description Definition Language. MPEG-7 metadata can be associated with media streams, such as MPEG-2 and MPEG-4, and can be inserted as additional information into the transport stream. At the user terminal, MPEG-7 can be used to locate structural or semantic components of a currently viewed or stored content. This facilitates search and retrieval allowing users to access parts of the data that is of interest to them.

In some embodiments the metadata may be structure according to an Ontology. OWL (Web Ontology Language as defined by the World Wide Web Consortium—W3C) is an example of an ontology description language. Any ontology language—even if their scope is not limited to that—can be used to describe metadata. The advantage is that such metadata will be described with a semantically rich description language, which may simplify their processing.

Several mechanisms are known for annotating content items with some metadata that describe the content at a higher level, and which can be automatically processed to help the user, e.g. by providing personalized content.

It will thus be appreciated that many techniques and algorithms are known for generating content metadata and that any suitable algorithm may be used without detracting from the invention. For example, the content metadata may be manually provided by a user or may be generated by automated annotation techniques.

Step 203 is followed by step 205 wherein the mobile phone 101 receives a request for a content item from the requesting unit 105.

Step 205 is followed by step 207 wherein the access right processor 111 proceeds to determine requester metadata. The requester metadata may comprise data about the requester such as e.g. an identifier, a group belonging, a relationship with the content owner, relationships with other individuals, etc. Optionally, this metadata may also include some information about previous content usage (e.g. number of exchanges, date of last exchange, frequency of exchanges, etc).

Thus the requester metadata may contain additional information about the requester and may for example be provided to the mobile phone 101 as part of the request. Alternatively or additionally the requester metadata may be determined in response to data for the first requester which is locally stored at the mobile phone 101. As an example, this information (such as: friend, relatives, date of birth, topics of interest, previous content usage, etc.) may be linked with entries in the phone-book of the mobile phone 101 and may have been entered by the users themselves.

Step 207 is followed by step 209 wherein the access right processor 111 determines an access right for the request.

In a simple embodiment, the access right processor 111 may comprise a simple rule which is evaluated for the requester metadata and the content metadata of the specific request. Thus, if the requester metadata and content metadata comprises data which meets a given requirement, a positive access right is determined and otherwise a negative access right is determined. Thus, a simple first order logic may be used. In such an embodiment, a rule generally links metadata about the requester with metadata about the requested content. A specific example of such a rule is the following:
If requester is requester-description and content is content-description then access-decision.

In some embodiments, the access right is further determined in response to usage data. The usage data may specifically reflect previous access right determinations and may allow for automated access rights management automatically learning from previous behaviour. Thus, the access right for the current request may be determined in response to an access right that was determined for a previous request.

As an example, the mobile phone 101 may comprise functionality for the user to manually grant access to a given content item. If this is done, the access right processor 111 register that given requester metadata resulted in access to a content item having given content metadata. Accordingly, when the new request is received, the access right processor 111 may compare the requester metadata and the content metadata to the requester metadata and the content metadata for the previous request. If the requester metadata and the content metadata match according to any suitable predefined similarity criteria, the access right processor 111 may grant access to the content item.

Thus, if the content metadata for the requested content item is similar (in accordance with a given similarity criterion) to content metadata for a previous content item and the requester metadata is similar (in accordance with a given similarity criterion) to requester metadata of a request that has previously been allowed access to the previous content item, the access right processor 111 determines a positive access right.

The similarity criteria may be based on a categorisation of requesters and/or content items. E.g., the access right processor 111 may define categories for the requesters and/or the content items. For example, the access right processor 111 may define requester categories corresponding to friends, business associates, family etc and may determine content categories corresponding to personal photos, personal addresses, family phone numbers, business content, etc.

In addition, the access right processor 111 may define rules or associations linking the categories. For example, it may be defined that the requester category of family is linked to the content category of family phone numbers, that the requester category of friends is linked to the content category of personal photos etc.

In such an embodiment, when the access right processor 111 receives a request for a content item, it may first evaluate the requester metadata to determine a requester category. If this is found, the access right processor ill may proceed to evaluate the content metadata for the requested content item to determine a content category. If this is found, the access right processor ill may proceed to evaluate the currently defined associations to determine if there is any link between the requester category and the content item category. If so, a positive access right is determined and otherwise a negative access right is determined.

In some embodiments, the links between categories of content metadata and categories of requester metadata are predefined. However, in other embodiments, the links may alternatively or additionally be determined in response to past usage data. In particular, a new link or association may be set-up if a given criterion is met. For example, if a given number of requesters within a given category have been allowed access to a given number of content items within a given content item category, an association may be set up between these thereby allowing all requesters within the given requester category to have access to all content items within the given content item category.

Furthermore, in some embodiments, the associations may be conditional links which only link if a given criterion is met. For example, an association between a given requester category and a given content item category may only allow access, if another criterion is met, such as e.g. that the requester has not already accessed any content items within this category.

As a specific example, the access right processor 111 may thus determine access rights based on a flexible and dynamically adapting set of rules. Rules can e.g. be based on any combination of first-order logic policies based on social interactions, usage and content. In one exemplary embodiment, three types of rules are defined, and rule sets are automatically expanded over time based on the use of the system and the user interactions.

In the specific example, the following three types of rules are used:
Generic rules—pre-defined, yet modifiable and expandable, rules which determine access for unnamed individuals to generic content described by particular metadata. Unnamed individuals here refer to a group of people which are usually specified by a periphrasis instead of being explicitly named. This can be a group (Ex: “friends from college”) or defined using metadata (Ex: people who are mentioned on this picture). Example of a generic rule:
   Friends of friends can access pictures shared with a mutual friend (Generic rule)
Specific rules—these rules determine access for specific individuals to specific content or access for specific individuals to content described by metadata or access for unnamed individuals to specific content. These rules are for instance created when the owner explicitly grants rights to a specific user to access particular content. They are usually used to more finely tune a generic rule. As such, specific rules may have precedence over generic rules. Example of a specific rule:
   Friends can access pictures they are on (Generic rule)
   My friend Frank can access any piece of content (Specific rule)
Meta-rules—pre-defined, yet modifiable, rules which define how to infer new generic rules from specific rules. Example of a meta-rule:
   If at least three members from the same group have access to the same pieces of content then grant access to the entire group (Meta-rule)

In the specific example, the system includes an initial set of generic rules, called the bootstrap rules, which are defined by the manufacturer or selected by the user (among several choices) during system initialisation. Then the system waits for an access request as a background task. Each time the system receives an access request, it processes the request based on the current rule sets and the information about the requester and the content.

As a second background task, the system also monitors the user activity. If the user directly exchanges some content with some individual (without the access control mechanism being involved), the system compares the user's activity with the rule-based decision. If no rule matches the current situation, the system may create a new specific rule. If the user decision contradicts the rule-based decision, then the system may update the rule sets by removing or adding a rule to match the situation. The addition or deletion of rules may be done autonomously or may be subject to user approval. In summary the rule sets may evolve over time:
Rule sets can be modified by adding or removing generic rules.
Rule sets can be modified by adding or removing specific rules.
Rule sets can be modified by abstracting a set of specific rules into a generic rule (via meta-rules).
Rule sets can be modified by adding a meta-rule.

In some embodiments, the access right processor 111 may further determine contextual metadata for the content items and may determine the access right in response to the contextual metadata. In some cases, the contextual metadata may simply be stored in the content item store 113 with the content items and the determination may simply comprise retrieving the data from the content item store 113.

Thus, in addition to content metadata, which relates to the content of the content item (e.g. the information stored in the content item itself), the content items may also be associated with metadata related to its context. For example a picture might include information about who appears on the picture or where or when it was taken. The mechanism of annotating content with contextual metadata may be performed at the creation of the content item and it will be appreciated that any suitable algorithm may be used including manual entry of context information by a user.

As an example, the context data may comprise information related to a user activity when the content item is created. For example, the user may manually enter information indicating that he is attending a party and may identify a number of other people also attending the party. Any pictures taken during this time may then automatically be tagged with this context information. When receiving a request for content items, the access right processor 111 may then further determine the access right in response to this context information. For example, the stored associations between content item categories may be conditional on the context information. As a specific example, requesters belonging the friends category may be allowed access to content items of the personal photos category, but pictures from the party may only be provided to people identified as attending the party.

Step 209 is followed by step 211 wherein a response is transmitted to the requesting unit 105. Specifically, if a positive access right is determined, the requested content item may be transmitted and otherwise an access refusal message may be transmitted.

In some embodiments, the determined access right may be presented to the user for acknowledgement or rejection. Thus, the system may merely provide an access control suggestion to the content owner or may autonomously make access control decisions based on user preferences. If the system behaves autonomously, then an audit system can optionally log all access control decisions.

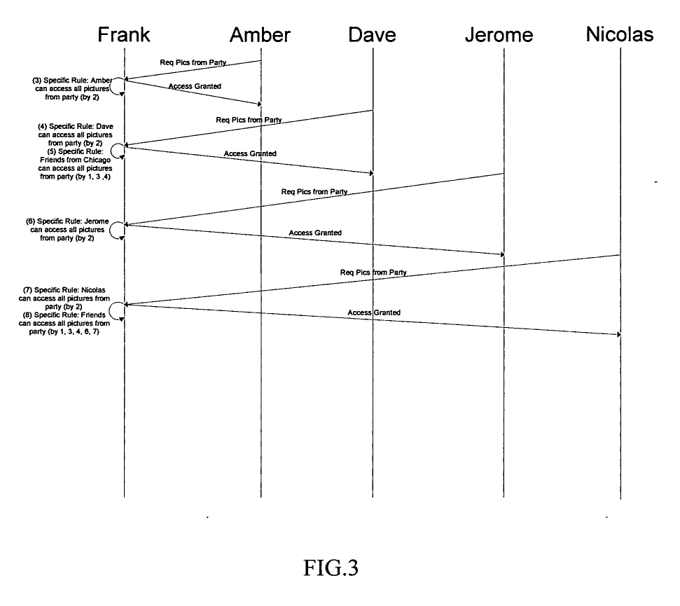

FIG. 3 illustrates a specific content item access example.

In this example the access right processor 111 comprises the following rules:
Rule 1: If a set number of pieces of content items with particular metadata are shared to a certain percentage of people from a particular group (defined by their metadata—from phonebook, vCard or profile) the entire group gets access to all of the content with that particular metadata (meta-rule)
Rule 2: If a particular user is granted access to a certain percentage of content with particular metadata, then they are granted access to all content with that particular metadata (meta-rule)
   Example Scenario

A series of pictures are taken at a party in Chicago. The pictures are annotated with the location of the event. Later, Amber a person who is in the user's “friends” area of the address book with a Chicago area code requests pictures from the party and the user grants access. Amber requests more pictures than the requisite amount needed to fire a meta-rule allowing her access to all pictures of that event. A specific rule is created that Amber can access all pictures from that event. After that another person who is in the user's “friends” area of the address book with a Chicago area code requests more pictures from that event (again more than the percentage required to fire the meta-rule) and the user grants access. This goes over the required percentage of people in the phone book with the same criteria (e.g. friend) being granted access to all content described by a set of metadata (from a particular event). After this, the meta-rule fires, creating a general rule allowing all friends in the phone book with a Chicago area code to have access to all pictures from that event.

Now, Jerome, who is in a different area code but still in the “friends” area of the address book, requests access to pictures from that same party. Access is granted by the user, and a meta-rule is fired granting him access to all pictures from that party. Nicolas, who is in a yet another area code but still in the friends group, also requests the requisite number of pictures from that party and the user grants access. Again, the meta-rule is fired, allowing Nicolas access to all the pictures from that event. Then another meta-rule is fired, creating a general rule that allows all people in the friends group of the phone book access to pictures from this event.

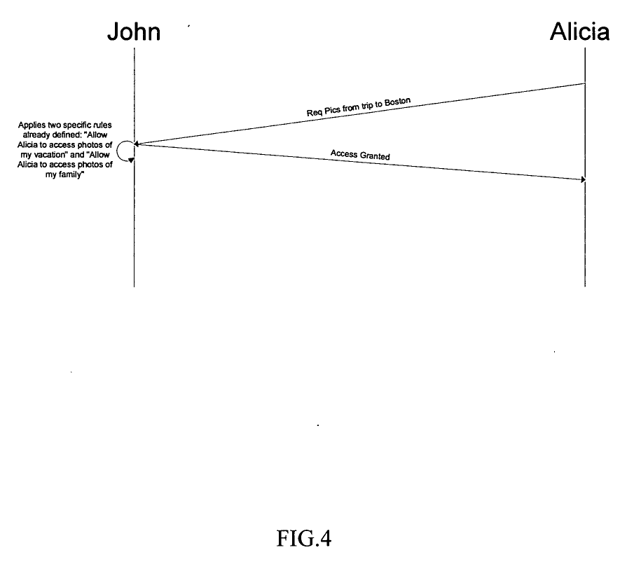

FIG. 4 illustrates another specific content item access example.

Example Scenario:

John and Alicia are co-workers. While John is on vacation this year, Alicia would like to see his pictures of his current trip to Boston. As John has previously shared photos of his family on vacation with her in the past, Alicia is granted access.

In this example, photos are annotated with the location of the vacation, Alicia appears as a “co-worker” in the address book of John and John device's access control system includes the following rules (which have been set up over time):
“Allow° Friends to access photos of my vacation”
“Allow Co-workers to access photos of work”
“Allow Alicia to access photos of my vacation”
“Allow Alicia to access photos of my family”

The request from Alicia contains metadata (e.g. vacation, family) about the kind of pictures she would like to access. Since there are already specific rules about such photos in the knowledge base (constructed through the history of interactions), John's access control logic fires the rules and Alicia is granted access to the vacation photos.

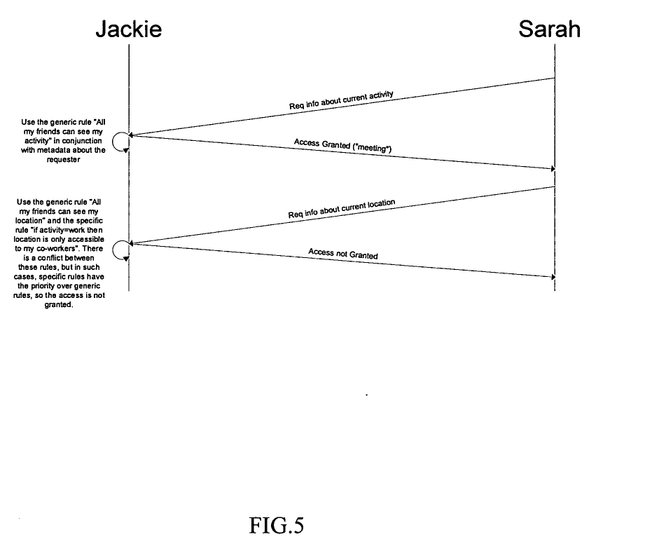

FIG. 5 illustrates another specific content item access example.

Example Scenario:

Sarah is going for a run along North Beach in San Francisco and takes a break on the beach. As she knows her friend Jackie is working close to the Science Museum, two blocks away, she asks the system for Jackie's activity. As they are friends she is able to see that Jackie is in a meeting. She tries to see the location, but for confidentiality reasons, Jackie's system does not let her friend see her location when she is working as she might be visiting a client. (In this example the system uses previous knowledge of Sarah and Jackie's friendship to determine if they can view each other's activity and locations). Jackie's device's access control system includes the following rules (among others):
generic rules:
   “All my friends can see my activity”
   “All my friends can see my location”
specific rule:

“If my activity is work, only my co-workers can see my location”

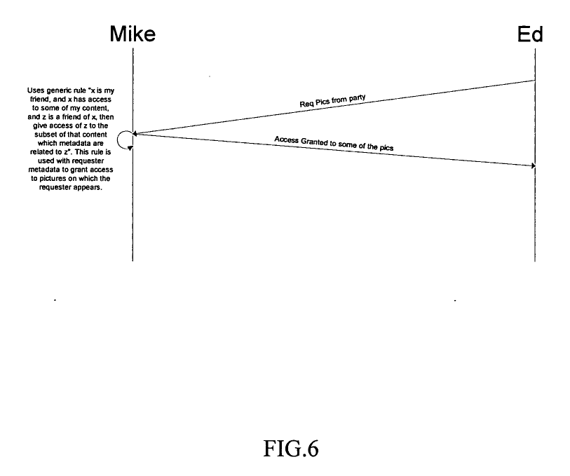

FIG. 6 illustrates another specific content item access example.

Example Scenario

Ed and Mike did not know each other but they have a friend in common and they were at the same party last Saturday, where they met. Ed would now like to see the pictures Mike took with his phone during the party. The system allows Ed to see the picture that he appears in. (In this example metadata about Ed are compared to contextual metadata of the pictures to check that he was on present during the party.)

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Similarly, functionality illustrated as implemented in a single processor may be implemented in a plurality of processors. For example, the functionality of the access right processor may be implemented in a single processing unit or may be distributed over a plurality of procession units. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

I/We claim

1. An apparatus comprising:
memory for storing a plurality of content items; and
a processor coupled to the memory and arranged to determine content metadata for the plurality of content items;
receive a request for a first content item of the content items;
determine requester metadata for the request, the requester metadata comprising data of a characteristic of a first requester of the request; and
determine an access right for the first requester to the first content item in response to the content metadata and the requester metadata.

2. The apparatus claimed in claim 1 wherein the processor is further arranged to determine past usage data for the plurality of content items; and to further determine the access right in response to the usage data.

3. The apparatus claimed in claim 2 wherein the processor is arranged to determine the access right as a positive access right if the first content item meets a similarity criterion with respect to another content item for which the past usage data indicates that a requester meeting a similarity criterion with respect to the first requester has obtained a positive access right.

4. The apparatus claimed in claim 1 wherein the processor is further arranged to determine contextual metadata for the plurality of content items; and to further determine the access right in response to the contextual metadata.

5. The apparatus claimed in claim 4 wherein the contextual metadata relates to a user context for a user associated with each of the plurality of content items.

6. The apparatus claimed in claim 1 wherein the processor is further arranged determine a category of the first requester in response to the requester metadata; and to determine the access right as a positive access right in response to a determination that at least one other requester belonging to that category has positive access rights.

7. The apparatus of claim 6 wherein the processor is arranged to determine the access rights of the at least one other requester in response to an access right determination for a previous request by the at least one other requester for the first content item.

8. The apparatus claimed in claim 1 wherein the processor is further arranged determine a category of the first content item in response to the content metadata; and to determine the access right as a positive access right in response to a determination that the first requester has a positive access right to at least one other content item belonging to that category.

9. The apparatus of claim 8 wherein the processor is arranged to determine the access rights for the at least one other content item in response to an access right determination for a previous request by the first requester for the at least one other content item.

10. The apparatus of claim 1 wherein the processor comprises access right associations linking at least a first content item characteristic with a first requester characteristic; and wherein the processor is arranged to determine a positive access right if a requester and a content item of a request by the requester are linked by an access rights association.

11. The apparatus claimed in claim 10 wherein the processor is further arranged to determine a requester category of the first requester in response to the requester metadata; and to determine the access right in response to an access rights association for at least one other requester of the requester category.

12. The apparatus claimed in claim 10 wherein the processor is further arranged to determine a content category of the first content item in response to the content metadata; and to determine the access right in response to an access rights association for at least one content item of the content category.

13. The apparatus of claim 10 wherein the processor is arranged to generate access right associations in response to a determination of an access right for a requester for a content item.

14. The apparatus of claim 1 wherein the processor is arranged to determine a positive access right if the content metadata for the first content item comprises an association to a characteristic of the first requester.

15. The apparatus of claim 14 wherein the characteristic is an identity.

16. The apparatus of claim 1 wherein the processor is arranged to determine the requester metadata in response to locally stored data for the first requester.

17. The apparatus of claim 1 wherein the processor is arranged to determine the access right in response to a user defined access right for at least one different content item.

18. The apparatus of claim 1 wherein the apparatus comprises a user interface for presenting the access rights to the user.

19. The apparatus of claim 1 wherein the apparatus comprises an interface for providing access for the first requester to the first content item only if a positive access right is determined.

20. A method of determining access rights to content items comprising:
storing a plurality of content items;
determining content metadata for the plurality of content items; receiving a request for a first content item of the content items;
determining requester metadata for the request, the requester metadata comprising data of a characteristic of a first requester of the request; and
determining an access right for the first requester to the first content item in response to the content metadata and the requester metadata.
